(19) United States
(12) Patent Application Publication
(10) Pub. No.: US 2026/0070461 A1
(43) Pub. Date: Mar. 12, 2026

(54) METHOD FOR SETTING AND EXECUTING FOLLOW-UP ACTION FOR OCPP MESSAGE AND CHARGING STATION MANAGEMENT SYSTEM THEREFOR

(71) Applicant: MONIT CO., LTD., Gwangju (KR)

(72) Inventors: Jin Seok YANG, Sejong-si (KR); Chung Youl LEE, Goyang-si (KR); Seong Ju PARK, Daejeon (KR)

(21) Appl. No.: 19/300,002

(22) Filed: Aug. 14, 2025

(30) Foreign Application Priority Data
Sep. 12, 2024 (KR) 10-2024-0124649

(51) Int. Cl. B60L 53/68; B60L 53/30

(52) U.S. Cl. CPC B60L 53/68; B60L 53/305

(57) ABSTRACT

A method for executing a follow-up action of an open charge point protocol (OCPP) message received from at least one charging point in a Charging Station Management System (CSMS), including querying a message action mapping table predetermined corresponding to identification information of the at least one charging point that has transmitted an OCPP message, and obtaining at least one action information corresponding to the OCPP message from the inquired message action mapping table, and executing the follow-up action according to the at least one action information obtained.

### CROSS REFERENCE TO RELATED APPLICATIONS

This application claims priority to Korean Patent Application No. 10-2024-0124649, filed on Sep. 12, 2024, in the Korean Intellectual Property Office, which is incorporated by reference herein in its entirety.

### FIELD OF THE INVENTION

The present disclosure relates to a method for setting and executing a follow-up action of an open charge point protocol (OCPP) message, and a Charging Station Management System (CSMS) therefor.

### BACKGROUND OF THE RELATED ART

Recently, as the depletion of fossil fuels and air pollution from their excessive use has become serious, research and development on the use of renewable energy and eco-friendly transportation are being actively conducted. Among eco-friendly transportation vehicles, electric vehicles do not emit any air pollutants during operation and do not cause noise pollution, so automakers around the world are rushing to launch them in the market. In addition, countries around the world are striving to develop and install electric vehicle charging systems to promote the adoption and seamless use of such eco-friendly electric vehicles.

Meanwhile, as the supply of charging points has rapidly increased in recent years, internationally compatible standard protocols have been proposed for efficient management of chargers or charging systems. In South Korea, there is an increasing demand to preoccupy the market by changing to a charger network protocol that follows the international standard.

For example, Open Charge Alliance (OCA) distributes OCPP as a protocol in an electric vehicle charging system, and currently, standardization work is underway as OCPP 2.0 is reflected in the IEC 63110 standard. OCPP is an application protocol for communication between an electric vehicle charger and a CSMS (Charging Station Management System), and is an open application protocol that enables the central management system to communicate between an electric vehicle charger and various electric vehicle charging companies. This OCPP is currently applied and in use at numerous electric vehicle charging stations and central management systems all over the world.

Meanwhile, the charger and the CSMS may communicate with each other through an open charge point protocol (OCPP) message, thereby smoothly performing a charging procedure. However, because the charging provider's business model, operational policy, technical requirements, and customer service strategy all affect the procedures and actions for charging, CSMS tends to be newly developed each time.

Therefore, there is a need for research on how CSMS can accommodate changes in charging procedures and actions.

### SUMMARY OF THE INVENTION

The present disclosure has been devised to solve the above problems, and an object of the present disclosure is to provide a method for setting and executing a follow-up action of an OCPP message, and an CSMS therefor.

According to an embodiment of the present disclosure, a method of executing a follow-up action of an OCPP message received from at least one charging point in a charging station management system (CSMS) includes querying a predetermined message action mapping table corresponding to identification information of a charging point that has transmitted the OCPP message, and obtaining at least one action information corresponding to the OCPP message from the inquired message action mapping table; and executing a follow-up action according to the obtained at least one action information.

According to another embodiment of the present disclosure, a charging station management system (CSMS) configured to execute a follow-up action of an OCPP message received from at least one charging point includes a message handler configured to inquire a predetermined message action mapping table corresponding to identification information of a charging point that has transmitted the OCPP message, and obtain at least one action information corresponding to the OCPP message from the inquired message action mapping table; and a hub action factory configured to execute a follow-up action according to the at least one action information obtained.

According to the embodiments of the present disclosure described above, by providing a method for setting and executing a follow-up action of an OCPP message, and an CSMS therefor, the CSMS can accommodate changes in charging procedures and actions that vary depending on the needs of various charging service providers, and thus can rapidly respond to changes in new charging technologies, policies, and user requirements, thereby greatly improving the operation efficiency of a charging station.

In addition, the complexity of the charging infrastructure can be effectively managed through the CSMS, and scalability and ease of maintenance can be secured in the future.

### BRIEF DESCRIPTION OF THE DRAWINGS

FIG. 1 is a diagram illustrating an internal block of a CSMS according to an embodiment of the present disclosure.

FIG. 2 is a diagram for describing an operation in which a control hub service module of FIG. 1 executes a follow-up action of a OCPP message.

FIG. 3 is a diagram illustrating an example of a message action mapping table managed by a control hub action set manager module of FIG. 1.

FIG. 4 is a flowchart illustrating a method in which a CSMS executes a follow-up action of an OCPP message according to an embodiment of the present disclosure.

### DETAILED DESCRIPTION OF THE PREFERRED EMBODIMENT

A detailed description of the present disclosure, which will be described later, refers to the accompanying drawings, which illustrate specific embodiments in which the present disclosure may be practiced as examples. These examples are described in detail to be sufficient for those skilled in the art to practice the present disclosure. It should be understood that the various embodiments of the present disclosure are different from each other but need not be mutually exclusive. For example, certain shapes, structures, and characteristics described herein may be implemented in other embodiments without departing from the spirit and scope of the present disclosure with respect to one embodiment. It should also be understood that the position or arrangement of individual components within each disclosed embodiment may be altered without departing from the spirit and scope of the present disclosure. Accordingly, the detailed description to be described below is not intended to be taken in a limited sense, and the scope of the present disclosure, if properly described, is limited only by the appended claims along with all the scope equivalent to those claimed by the claims. Similar reference numerals in the drawings refer to the same or similar functions across several aspects.

The components according to the present disclosure are components defined by functional classification rather than physical classification, and may be defined by functions performed by each. Each component may be implemented as hardware or a program code and a processing unit that perform each function, and functions of two or more components may be included in one component to be implemented. Accordingly, it should be noted that the names given to the components in the following embodiments are not intended to physically distinguish each component, but are given to imply a representative function in which each component is performed, and the technical spirit of the present disclosure is not limited by the names of the components.

Hereinafter, exemplary embodiments of the present disclosure will be described in more detail with reference to the drawings.

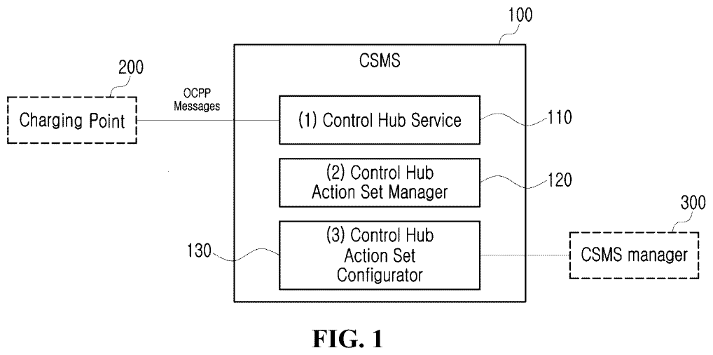

FIG. 1 is a diagram illustrating an internal block of an CSMS according to an embodiment of the present disclosure.

The CSMS 100 includes a control hub service module 110, a control hub action set manager module 120, and a control hub action set configurator module 130.

When the OCPP message transmitted by the WebSocket method is received from the charging point 200, the control hub service module 110 executes a follow-up action corresponding to the OCPP message by using the message information and the action information described in the control hub action sets Control Hub Action Set and CHAS managed by the control hub action set manager module 120. In this case, the follow-up action may include at least one action, and may be executed by various methods, for example, an internal call, a serverless function call, a web hook, and the like.

The control hub action set manager module 120 manages CHAS data and manages binding information of the charging point 200 and CHAS data. Here, the binding information refers to connection information between a specific charging point and a specific action set, and the action set refers to a set composed of a series of actions or functions for performing a specific command. In addition, one action set may be set per charging point, and a specific message among all messages received from the charging point may be determined in the action set to define a follow-up action to be performed for each message. For example, the action set for the slow charger may define a follow-up action such as turning on the charger power, user authentication, and transaction start recording.

The control hub action set configurator module 130 sets and manages the operation of the system, and provides the CSMS manager 300 with an environment in which CHAS data may be edited.

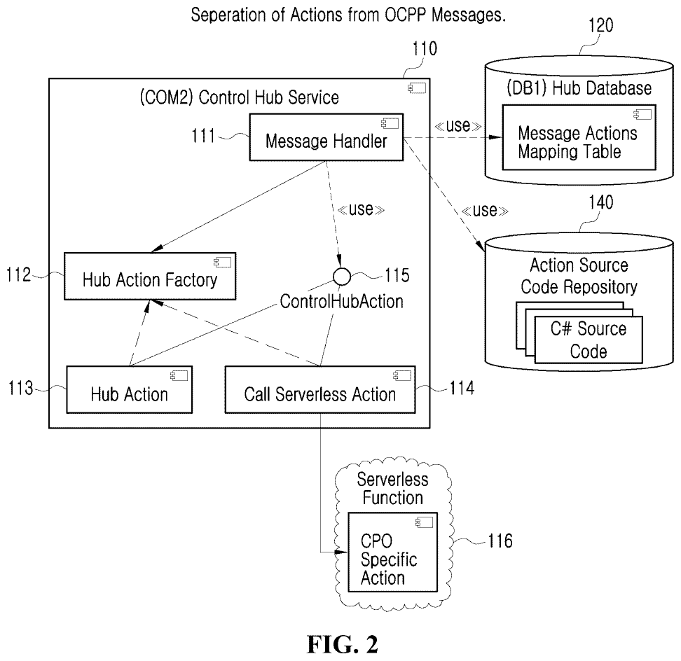

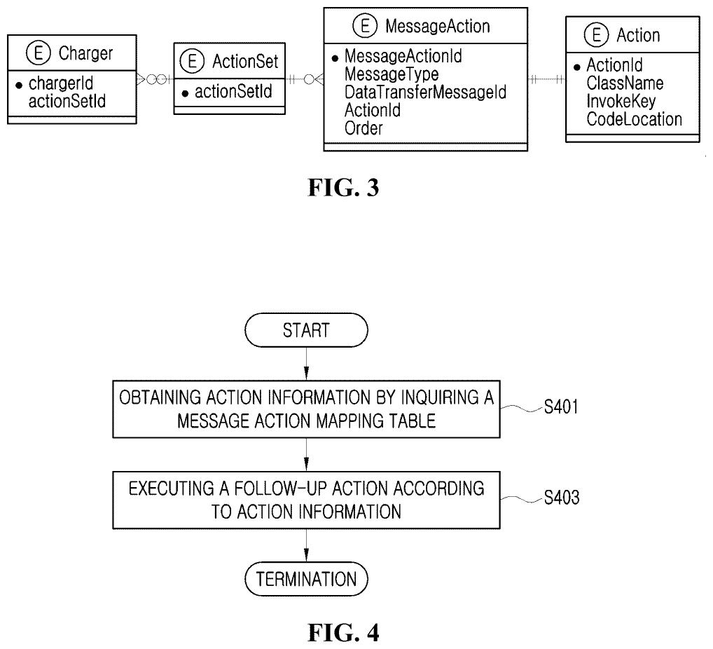

FIG. 2 is a diagram for describing an operation in which the control hub service module of FIG. 1 executes an action of an OCPP message, and FIG. 3 is a diagram illustrating an example of a message action mapping table managed by the control hub action set manager module of FIG. 1.

The control hub service module 110 shown in FIG. 2 includes a message handler 111 and a hub action factory 112.

The message handler 111 receives an OCPP message from at least one charging point, inquires a predetermined message action mapping table corresponding to identification information (Identifier, ID) of a charging point that has transmitted the OCPP message, and retrieves a follow-up action including at least one action information corresponding to the OCPP message from the inquired message action mapping table. Here, the identification information of the charging point is information known in advance through the WebSocket URL, and for example, the charger identifier may be known through the charger identifier (charger identifier) in the URL at the time of the initial websocket connection such as ‘wss://localhost:8080/{charger identifier}’.

In addition, it is assumed that the message action mapping table is managed by the control hub action set manager module 120, and in FIG. 2, the message action mapping table is managed by the hub databases DB which are detailed components of the control hub action set manager module.

Message information and action information are described in the message action mapping table, and as shown in FIG. 3, the message action mapping table includes first to fourth tables, that is, an Charger table, an ActionSet table, an MessageAction table, and an Action table.

The Charger table describes basic information of the charging point, and includes a unique identifier (chargeId) of the charger and an identifier (actionSetId) of an action set related to the charger. In addition, the Charger table may set one ActionSet table.

The ActionSet table describes a series of action information to be performed by the charging point, and includes an identifier (actionSetId) of the action set. Here, the ActionSet table may set at least one MessageAction table.

The MessageAction table describes action information corresponding to a message type, and includes an identifier (MessageActionId) of a message action, a message type (MessageType), an identifier (DataTransferMessageId) of a data transmission message, an identifier (ActionId) of an action to be performed on a message, and an execution order (Order) of actions when multiple actions are defined for the same message type. Here, the message type refers to the type of the OCPP message, and may be, for example, a boot notification, a start transaction, a stop transaction, an authentication, a dataTrasnsfer, and the like.

The Action table describes action information to be actually performed, and includes a unique identifier (ActionId) of an action, a class name (ClassName) for implementing the action, an invoke key (InvokeKey) for calling the action, and a code location (CodeLocation) of a source code for implementing the action.

In more detail, the message handler 111 checks the message type of the OCPP message by querying the message action mapping table using the serial number of the charging point. That is, the MessageType of the MessageAction table of FIG. 3 is checked.

Then, the message handler 111 obtains at least one action information corresponding to the message type. That is, ClassName of the Action table of FIG. 3 is called.

The hub action factory 112 executes an action according to at least one action information obtained from the message handler 111.

More specifically, the hub action factory 112 generates an action object corresponding to the at least one action information, that is, the Hub Action 113, or generates an action object, that is, the Call Serverless Action 114, executing an action implemented in an external system, through the ClassName loaded by the message handler 111. The Call Serverless Action 114 may have various functions as an action object that executes an action implemented in an external system, such as a cloud server, at runtime, thereby providing an extension point for the action. In addition, instead of modifying the CSMS by using such an expansion mechanism, only necessary elements may be additionally developed to plug-in the CSMS.

The hub action factory 112 then executes the Hub Action 113 and the Call Serverless Action 114 according to the order defined in the MessageAction table of FIG. 3. In this case, the Call Serverless Action 114 is executed by calling a serverless function 116 of a serverless platform defined in InvokeKey of the Action table of FIG. 3. Here, the serverless function is a method of cloud computing, providing an environment in which code may be executed without managing a server, and consists of short and independent code in functional units. In addition, since the serverless function is executed only when there is a request and is automatically terminated after execution, it has the advantage of being efficient and highly scalable in terms of cost.

As another example, the message handler 111 may retrieve the CodeLocation from the Action table of FIG. 3 to obtain at least one action information corresponding to the message type of the OCPP message.

In this case, the hub action factory 112 loads the source code indicated by the CodeLocation loaded by the message handler 111 from the action source code storage 140 to generate an action object corresponding to at least one action information, that is, the Hub Action 113, or generates the Call Serverless Action 114 for executing an action implemented in an external system. By executing the action through the dynamic loading method using the source code in this way, the system user has the advantage of being able to directly develop and execute the source code without a request for modification to the system.

Meanwhile, the control hub action 115 refers to an action corresponding to the OCPP message received by the CSMS, and for example, an action of making a payment request when an OCPP message having a message type of StopTransaction is received corresponds to one of the control hub actions.

Therefore, assuming a control hub action for requesting payment when an OCPP message of which the message type is StopTransaction is received, the message handler 111 automatically executes the payment action through the hub action factory 112 when receiving the OCPP message of which the message type is StopTransaction.

FIG. 4 is a flowchart illustrating a method of executing a follow-up action of an OCPP message by an CSMS according to an embodiment of the present disclosure.

When an OCPP message is received from at least one charging point, the CSMS inquires a predetermined message action mapping table corresponding to the identification information of the charging point that transmitted the OCPP message, and obtains at least one action information corresponding to the OCPP message from the inquired message action mapping table. (S401)

Thereafter, the CSMS executes a follow-up action according to at least one action information obtained in the S401. (S403)

The method of executing the follow-up action of the OCPP message according to the present disclosure may be implemented in the form of program instructions that may be executed through various computer components and recorded in a computer-readable recording medium. The computer-readable recording medium may include program instructions, data files, data structures, and the like alone or in combination.

The program instructions recorded in the computer-readable recording medium may be specially designed and configured for the present disclosure or may be known to and used by those skilled in the field of computer software.

Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions such as a ROM, a RAM, a flash memory, and the like.

Examples of program instructions include not only machine language codes such as those generated by a compiler, but also high-level language codes that may be executed by a computer using an interpreter or the like. The hardware device may be configured to operate as one or more software modules to perform processing according to the present disclosure, and vice versa.

Although various embodiments of the present disclosure have been illustrated and described above, the present disclosure is not limited to the specific embodiments described above, and various modifications can be made by a person skilled in the art to which the present disclosure belongs without departing from the gist of the present disclosure claimed in the claims, and such modifications should not be individually understood from the technical spirit or the prospect of the present disclosure.

### DESCRIPTION OF SYMBOLS

100: CSMS
110: Control hub service module
120: Control hub action set manager module
130: Control hub action set configurator module
140: Source code storage
200: Charging point
300: CSMS manager
111: Message handler
112: Hub action factory
113: Hub Action
114: Call Serverless Action
115: Control hub action
116: Serverless function

What is claimed is:

1. A method of executing a follow-up action of an open charge point protocol (OCPP) message received from at least one charging point in a Charging Station Management System (CSMS), the method comprising:
querying a message action mapping table predetermined corresponding to identification information of the at least one charging point that has transmitted the OCPP message, and obtaining at least one action information corresponding to the OCPP message from the inquired message action mapping table; and
executing the follow-up action according to the at least one action information obtained.

2. The method of claim 1, wherein the message action mapping table comprises:
a first table including the identification information (chargerID) of the at least one charging point;
a second table including action set identifiers (Identifier, ID);
a third table including a message type (MessageType) of the OCPP message and an order of execution of actions; and
a fourth table including a class name (ClassName), an invoke key (InvokeKey), and a code location (CodeLocation) of a source code for implementing an action.

3. The method of claim 2, wherein the obtaining the at least one action information comprises:
identifying the MessageType of the third table; and
obtaining the at least one action information mapped to the MessageType of the OCPP message.

4. The method of claim 2, wherein the executing the follow-up action comprises:
generating an action object corresponding to the at least one action information; and
executing the generated action object according to the order defined in the third table.

5. The method of claim 4,
wherein the obtaining the at least one action information includes retrieving the ClassName from the fourth table, and
wherein the action object is generated through the ClassName.

6. The method of claim 4,
wherein the obtaining the at least one action information includes retrieving the CodeLocation from the fourth table, and
wherein the action object is generated by loading the source code indicated by the CodeLocation from a source code storage.

7. The method of claim 2, wherein the executing the follow-up action comprises:
generating an action object for executing the action implemented in an external system of the CSMS; and
executing the generated action object according to the order defined in the third table.

8. The method of claim 7, wherein the executing the action object includes calling a serverless function of a serverless platform defined in the InvokeKey included in the fourth table.

9. A charging station management system (CSMS) for executing a follow-up action of an open charge point protocol (OCPP) message received from at least one charging point, the charging station management system comprising:
a message handler configured to query a predetermined message action mapping table predetermined corresponding to identification information of the at least one charging point that has transmitted the OCPP message, and obtaining at least one action information corresponding to the OCPP message from the inquired message action mapping table; and
a hub action factory configured to execute the follow-up action according to the at least one action information obtained.

10. The charging station management system of claim 9, wherein the message action mapping table comprises:
a first table including the identification information (chargerID) of the at least one charging point;
a second table including action set identifiers (Identifier, ID);
a third table including a message type (MessageType) of the OCPP message and an order of execution of actions; and
a fourth table including a class name (ClassName), an invoke key (InvokeKey), and a code location (CodeLocation) of a source code implementing the actions.

11. The charging station management system of claim 10, wherein the message handler is further configured to identify the MessageType of the third table, and obtain the at least one action information mapped to the MessageType.

12. The charging station management system of claim 10, wherein the hub action factory generates an action object corresponding to the at least one action information, and executes the generated action object according to the order defined in the third table.

13. The charging station management system of claim 12,
wherein the obtaining the at least one action information includes retrieving the ClassName from the fourth table, and
wherein the action object is generated through the ClassName.

14. The charging station management system of claim 12,
wherein the obtaining the at least one action information includes retrieving the CodeLocation from the fourth table, and
wherein the action object is generated by loading the source code indicated by the CodeLocation from a source code storage.

15. The charging station management system of claim 10, wherein the hub action factory generates an action object for executing an action implemented in an external system of the CSMS, and executes the generated action object according to the order defined in the third table.

16. The charging station management system of claim 15, wherein executing the action object includes calling a serverless function of a serverless platform defined in the InvokeKey included in the fourth table.
